(19) United States
(12) Patent Application Publication
(10) Pub. No.: US 2020/0191112 A1
(43) Pub. Date: Jun. 18, 2020

(54) HYDROELECTRIC POWER PLANT

(71) Applicant: INSTITUT POLYTECHNIQUE DE GRENOBLE, Grenoble (FR)

(72) Inventors: Thierry MAITRE, SAINT ISMIER (FR); Kenny BERNARD, GRENOBLE (FR); Hugues FILIPUTTI, MONESTIER DE CLERMONT (FR)

(21) Appl. No.: 16/630,403

(22) PCT Filed: Jul. 12, 2018
(86) PCT No.: PCT/FR2018/051767

§ 371 Date: Jan. 10, 2020

(30) Foreign Application Priority Data
Jul. 12, 2017 (FR) 1756637

(51) Int. Cl. F03B 13/26; F03B 17/06

(52) U.S. Cl. CPC F03B 13/264; F03D 3/068; F03B 17/061

(57) ABSTRACT

A hydroelectric power plant for a water stream includes an electromechanical converter and a turbine driving the converter. The turbine includes two vertical supports parallel to the flow and, between the supports, driving blades moved by the hydrodynamic lift forces, connected at each end to a drive component. The turbine further includes wheels driven by the drive component and assembled on the supports. The hydroelectric power plant includes at least first, second, and third travel areas where each drive component extends rectilinearly, the leading edges of the blades being arranged horizontally plus or minus 5° at least in the first and second travel areas. Each support includes guides and each blade includes elements abutting against the guides.

The present patent application claims the priority benefit of French patent application FR17/56637 which is herein incorporated by reference.

### BACKGROUND

The present disclosure concerns a hydroelectric power plant.

### DISCUSSION OF THE RELATED ART

There exist hydroelectric power plants which use the natural kinetic energy of water streams, also called hydraulic turbine engines, which require little civil works and generate an electric power which varies along with the flow rate of the stream. They have the advantage of causing a decreased manufacturing and installation cost as compared with a hydroelectric power plant associated with a dam and do not disturb the specific life of the stream. Further, the mechanical-to-electrical conversion of hydraulic turbine engines may be performed out of the water. It may be provided for the hydraulic turbine engines to float on the stream to avoid having to build foundations and to adapt to the natural variation of the water level.

A hydraulic turbine engine generally comprises blades, also called foils, which rotate a shaft when they are submerged in the water stream. The displacement of the blades may be mainly due to lift forces or to drag forces. The power plant is said to be an axial flow power plant when the flow is parallel to the rotation axis of the shaft and to be a cross-flow power plant when the flow is perpendicular to the rotation axis of the shaft.

However, the efficiency of existing hydraulic turbine engines may be low, particularly for cross-flow hydraulic turbine engines. Further, the structures of existing hydraulic turbine engines may be complex, which causes high manufacturing, installation, and maintenance costs. Further, for certain applications, existing hydraulic turbine engines, in particular axial flow hydraulic turbine engines, may have an excessive bulk, be in terms of height or of width, and/or have a low modularity, which is not desirable. Finally, hydraulic turbine engines have a rotation speed which decreases as their size increases, which increases the torque to be transmitted and complicates the electric power generation.

### SUMMARY

An object of an embodiment is to overcome all or part of the disadvantages of previously-described hydraulic turbine engines.

Another object of an embodiment is to increase the efficiency of the hydraulic turbine engine.

Another object of an embodiment is for the hydraulic turbine engine to have a simple structure.

Another object of an embodiment is to decrease the bulk of the hydraulic turbine engine.

Thus, an embodiment provides a hydroelectric power plant for a stream comprising an electromechanical converter and a turbine capable of driving the electromechanical converter, the turbine comprising two vertical supports parallel to the stream flow, a float connected to each support and, between the supports, driving blades moved by hydrodynamic lift forces, connected at each end to a drive component comprising a chain or a belt forming a closed loop, the turbine further comprising wheels driven by the drive component and assembled on the supports, each blade comprising a leading edge and a trailing edge, the hydroelectric power plant comprising at least first, second, and third travel areas where each drive component extends rectilinearly, the leading edges of the blades being arranged horizontally plus or minus 5° at least in the first and second travel areas, the blades being fully submerged at least across a portion of the first and second travel areas.

According to an embodiment, each blade is further connected at each end to one of the supports.

According to an embodiment, in a vertical plane parallel to the supports, the leading edge of each blade is capable of displacing rectilinearly in each of the first, second, and third travel areas.

According to an embodiment, the blades are totally emerged in the third travel area.

According to an embodiment, the blades displace substantially horizontally plus or minus 5° in the third travel area.

According to an embodiment, each blade is assembled to freely rotate with respect to the drive components around an axis located in the blade half on the side of the leading edge of the blade.

According to an embodiment, each support comprises guides and each blade comprises elements capable of abutting against the guides.

According to an embodiment, for each blade, the elements are secured to the blade in the blade half on the side of the trailing edge of the blade.

According to an embodiment, the guides of each support comprise a first rectilinear guide in the first travel area, downstream, according to the stream flow direction, of the drive component in the first travel area, and a second rectilinear guide in the second travel area, downstream, according to the stream flow direction, of the drive component in the second travel area.

According to an embodiment, the blades are capable, under the action of hydrodynamic forces, of cambering in the downstream direction in the first and second travel areas.

### BRIEF DESCRIPTION OF THE DRAWINGS

The foregoing and other features and advantages will be discussed in detail in the following non-limiting description of specific embodiments in connection with the accompanying drawings, in which:

FIG. 1 is a partial simplified perspective view of an embodiment of a hydraulic turbine engine;

FIGS. 2 and 3 respectively are a perspective view and a top view, partial and simplified, of an embodiment of the turbine of the hydraulic turbine engine shown in FIG. 1;

FIGS. 4 and 5 respectively are a perspective view and a side view of certain elements of the turbine shown in FIGS. 2 and 3;

FIG. 6 is a partial simplified top view of certain elements of the turbine shown in FIGS. 2 and 3;

FIGS. 7 and 8 respectively are a perspective view and a side view, partial and simplified, of the hydraulic turbine engine shown in FIG. 1 illustrating the operation thereof;

FIGS. 9 to 12 are partial simplified enlarged side views of four portions of the hydraulic turbine engine of FIG. 1;

FIG. 13 is a view similar to FIG. 7 of another embodiment of a hydraulic turbine engine;

FIG. 14 is a view similar to FIG. 5 of another embodiment of a hydraulic turbine engine comprising a blade disengaging system;

FIGS. 15 to 18 and 20 are partial simplified cross-section views of a portion of the hydraulic turbine engine of FIG. 14 at successive steps of a blade disengaging operation and FIG. 19 is a perspective view of the portion of the hydraulic turbine engine shown in FIG. 18;

FIGS. 21 to 23 are partial simplified cross-section views of a portion of the hydraulic turbine engine of FIG. 14 at successive steps of a blade engaging operation;

FIG. 24 is a partial simplified cross-section view shown two blades in disengaged position;

FIGS. 25 and 26 are views similar to FIG. 14 of an alternative embodiment of the hydraulic turbine engine shown in FIG. 14;

FIG. 27 is a partial simplified cross-section view of an alternative embodiment of the disengaging system of the hydraulic turbine engine of FIG. 14; and

FIGS. 28 and 29 are partial simplified cross-section views of another embodiment of a blade in two different positions of the blade.

### DETAILED DESCRIPTION

In the following description, when reference is made to terms qualifying absolute positions, such as terms “front”, “rear”, “top”, “bottom”, “left”, “right”, etc., or relative positions, such as terms “above”, “under”, “upper”, “lower”, etc., or to terms qualifying directions, such as terms “horizontal”, “vertical”, etc., it is referred to the orientation of the drawings or to a hydroelectric power plant in a normal position of use. The terms “approximately”, “substantially”, “about”, and “in the order of” are used herein to designate a tolerance of plus or minus 10%, preferably of plus or minus 5%, of the value in question. In relation with directions or angles, the terms “approximately”, “substantially”, “about”, and “in the order of” are used herein to designate a tolerance of plus or minus 10°, preferably of plus or minus 5°, of the value in question. Further, only those elements which are necessary to the understanding of the present invention will be described and shown in the drawings. In particular, the structure and the operation of the electromechanical converters of hydroelectric power plants as well as the floatation members are well known by those skilled in the art and are not described in detail. In the following description, adjectives “upstream” and “downstream” are used to distinguish elements of a hydraulic turbine engine at least partially submerged in a stream with respect to the stream flow direction.

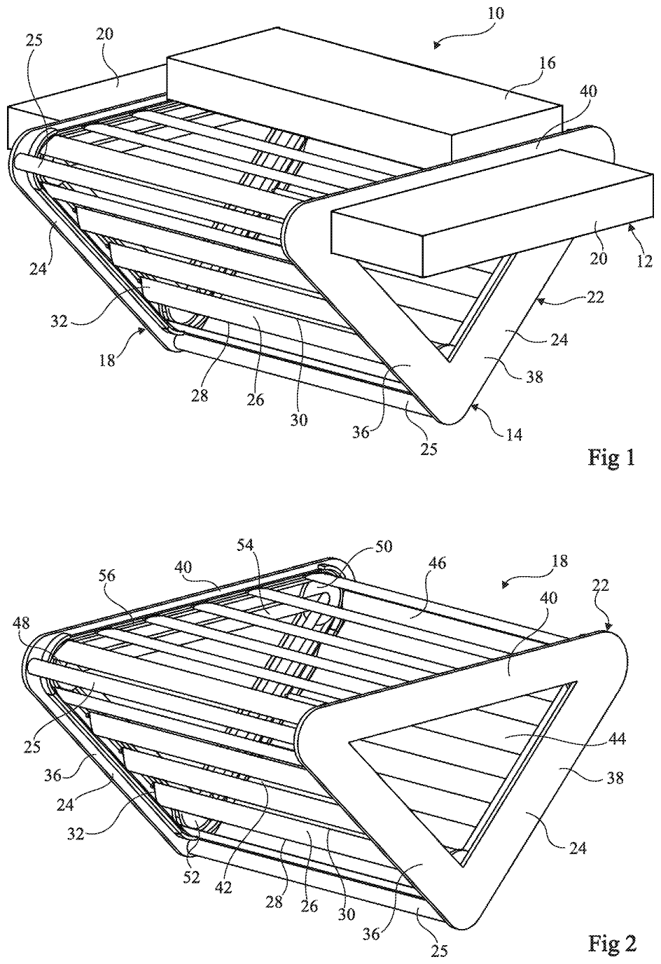

FIG. 1 is a partial simplified perspective view of an embodiment of a hydraulic turbine engine 10. Hydraulic turbine engine 10 is capable of delivering an electric power which may vary from 1 kW to 100 kW.

Hydraulic turbine engine 10 comprises a floatation member 12 and a turbine engine 14. Turbine engine 14 comprises an electromechanical converter 16 driven by a turbine 18. According to an embodiment, floatation member 12 comprises two floats 20 arranged on either side of turbine 18. Floats 20 are schematically represented by parallelepipeds in FIG. 1. Electromechanical converter 16 may be coupled to the electric network.

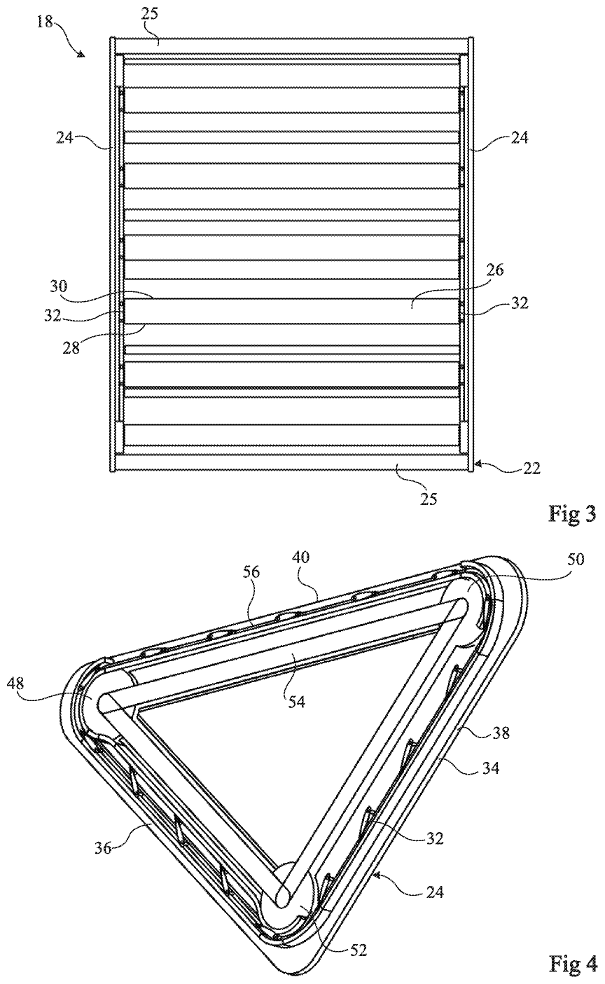

FIGS. 2 and 3 respectively are a perspective view and a top view of an embodiment of turbine 18.

Turbine 18 comprises a frame 22 which, according to an embodiment, comprises two supports 24 connected by cross members 25. Turbine 18 comprises, between the two supports 24, N driving blades 26, where N is an integer which for example varies from 8 to 32. According to an embodiment, each driving blade 26 is a straight blade with a substantially horizontal direction. Each blade 26 comprises a leading edge 28, a tapered trailing edge 30, and two opposite lateral ends 32.

Each blade 26 may have, in a vertical plane, an airfoil profile, for example, a symmetrical or dissymmetrical biconvex profile, a planar hollow profile, or a double-bend profile. Preferably, the relative thickness of the profile is smaller than or equal to 18%. Preferably, for each blade 26, the profile of blade 26 is substantially constant over the most part of the span of blade 26.

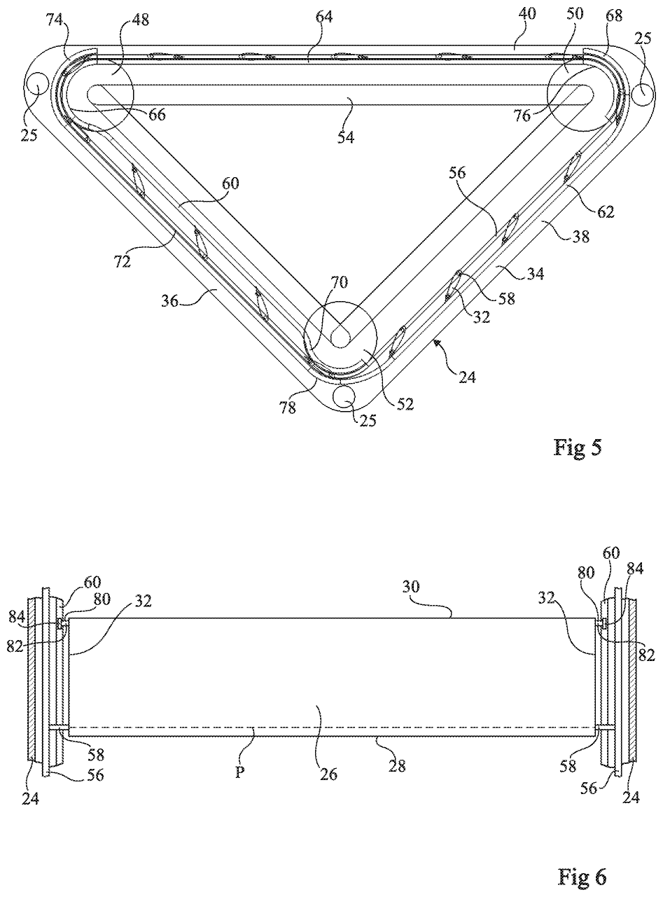

FIGS. 4 and 5 respectively are a perspective view and a front view of an embodiment of support 24. The lateral ends 32 of blades 26 located on the side of support 24 are further shown in FIGS. 4 and 5.

In the present embodiment, each support 24 comprises a plate 34 comprising three branches 36, 38, 40 connected to one another at their ends in a triangle. Each plate 34 is arranged in the stream according to a substantially vertical plane parallel to the stream flow direction.

The branches are distributed in:
an upstream branch 36 intended, in operation, to be at least partially submerged in the stream in the most upstream position and extending along a direction inclined with respect to the horizontal direction;
a downstream branch 38 intended, in operation, to be at least partially submerged in the stream in the most downstream position and extending along a direction inclined with respect to the horizontal direction; and
an upper branch 40 capable, in operation, of being submerged in the water stream or maintained emerged and extending along a substantially horizontal direction.

As shown in FIG. 2, the upstream branches 36 of supports 24 delimit together an upstream travel area 42. The downstream branches 38 of supports 24 delimit together a downstream travel area 44. The upper branches 40 of supports 24 delimit together an upper travel area 46.

At each corner of plate 34, support 24 comprises a wheel assembled to freely rotate on a shaft, not shown in the drawings, secured to plate 34. In the present embodiment, each support 24 comprises three wheels 48, 50, 52, more precisely an upper front wheel 48 located in the most upstream corner of plate 34, an upper back wheel 50 located in the most downstream corner of plate 34, and a lower wheel 52 located in the lowest corner of plate 34. The rotation axes of wheels 48, 50, 52 are substantially parallel and horizontal, and for each support 24, the wheels 48, 50, 52 connected to support 24 are substantially located in a same plane. Each support 24 may further comprises a reinforcement 54 located on the side of wheels 48, 50, 52 opposite to plate 24 and connected to the shafts having wheels 48, 50, 52 rotating around them. According to an embodiment, the rotation axes of the upper front wheels 48 are confounded, the rotation axes of the upper back wheels 50 are confounded, and the rotation axes of the lower wheels 52 are confounded. One pair, two pairs, or three of the pairs of wheels 48, 50, and 52 may comprise a common rotation shaft, not shown, crossing the turbine. At least one of wheels 48, 50, 52 is connected to electromechanical converter 16 by a mechanism, not shown, and drives electromechanical converter 16 when it is rotated.

Each support 24 comprises a chain 56, schematically shown in the drawings, extending around the three wheels 48, 50, 52 and capable of rotating wheels 48, 50, 52 when it is displaced. As an example, each chain 56 may comprise a succession of links, not shown in the drawings, which are jointed together, the links being capable of cooperating with the outer edge of each wheel 48, 50, 52. As a variation, each chain 56 may be replaced with any type of drive component, for example, a belt, particularly a flat belt, a notched belt, a V belt, a ribbed belt, or a round belt (also called cable).

FIG. 6 shows a bottom view of one of the blades 26 of upstream travel area 42 and of the chains 56 located on either side of blade 26. Each blade 26 is connected to chains 56 at its lateral ends 32. According to an embodiment, each blade 26 is connected to each chain 56 by a connection element 58. Connection elements 58 enable blade 26 to rotate with respect to chains 56 around a substantially horizontal rotation axis P. According to an embodiment, rotation axis P is located in the half of blade 26 on the side of leading edge 28, preferably in the quarter of blade 26 containing the leading edge.

In operation, turbine 18 is at least partially submerged in a stream, leading edges 28 being maintained substantially horizontal. The blades 26 submerged in the stream are, under the action of lift forces, capable of causing the displacement of chains 56.

As shown in FIGS. 4 and 5, each support 24 comprises guides which at least partly project from plate 34 of support 24 towards the inside of turbine 18. Each guide plays the role of a stop which limits the rotating motion of each blade 26 with respect to chains 56.

According to an embodiment, each support 24 comprises:
a main upstream guide 60 which extends substantially rectilinearly on the upstream branch 36 downstream of chain 56;
a main downstream guide 62 which extends substantially rectilinearly on the downstream branch 38 downstream of chain 56;
an upper guide 64 which extends substantially rectilinearly on upper branch 40 under chain 56;
a main upstream upper transition guide 66 connecting the upper end of main upstream guide 60 and the upstream end of upper guide 64, particularly comprising a cylindrical portion covering upper front wheel 48, having its axis corresponding to the rotation axis of upper front wheel 48 and a diameter smaller than the diameter of the circle followed by chain 56 when it is guided by upper front wheel 48;
a main downstream upper transition guide 68 continuing the upper end of downstream guide 62, particularly comprising a cylindrical portion covering upper back wheel 50, having its axis corresponding to the rotation axis of upper back wheel 50 and a diameter greater than the diameter of the circle followed by chain 56 when it is guided by upper back wheel 50; and
a main lower transition guide 70 continuing the lower end of main upstream guide 60, particularly comprising a cylindrical portion covering lower wheel 52, having its axis corresponding to the rotation axis of lower wheel 52 and a diameter smaller than the diameter of the circle followed by chain 56 when it is guided by lower wheel 52.

According to an embodiment, each support 24 may further comprise:
a secondary upstream guide 72 which extends substantially rectilinearly on upstream branch 36 upstream of chain 56;
a secondary upstream upper transition guide 74 connecting the upper end of secondary upstream guide 72, particularly comprising a cylindrical portion having its axis corresponding to the rotation axis of upper front wheel 48 and a diameter greater than the diameter of the circle followed by chain 56 when it is guided by upper front wheel 48;
a secondary downstream upper transition guide 76 continuing the back end of upper guide 64 and particularly comprising a cylindrical portion having its axis corresponding to the rotation axis of upper back wheel 50 and a diameter smaller than the diameter of the circle followed by chain 56 when it is guided by upper back wheel 50; and
a secondary lower transition guide 78 connecting the lower end of secondary upstream guide 72 to the lower end of main downstream guide 62, particularly comprising a cylindrical portion having its axis corresponding to the rotation axis of lower wheel 52 and a diameter greater than the diameter of the circle followed by chain 56 when it is guided by lower wheel 52.

As shown in FIG. 6, according to an embodiment, turbine 18 comprises, for each blade 26, bearing elements 80 secured to ends 32 of blade 26, each bearing element 80 being capable of coming into contact with one of guides 60, 62, 64, 66, 68, 70, 72, 74, 76, and 78 during the displacement of blade 26. According to an embodiment, each bearing element 80 comprises a lug 82 projecting from a lateral end 32 of blade 26, preferably from the quarter containing the trailing edge 30 of the profile of blade 26. Each lug 82 is provided with a roller 84 capable of rotating and/or of sliding against one of guides 60, 62, 64, 66, 68, 70, 72, 74, 76, and 78 during the displacement of blade 26.

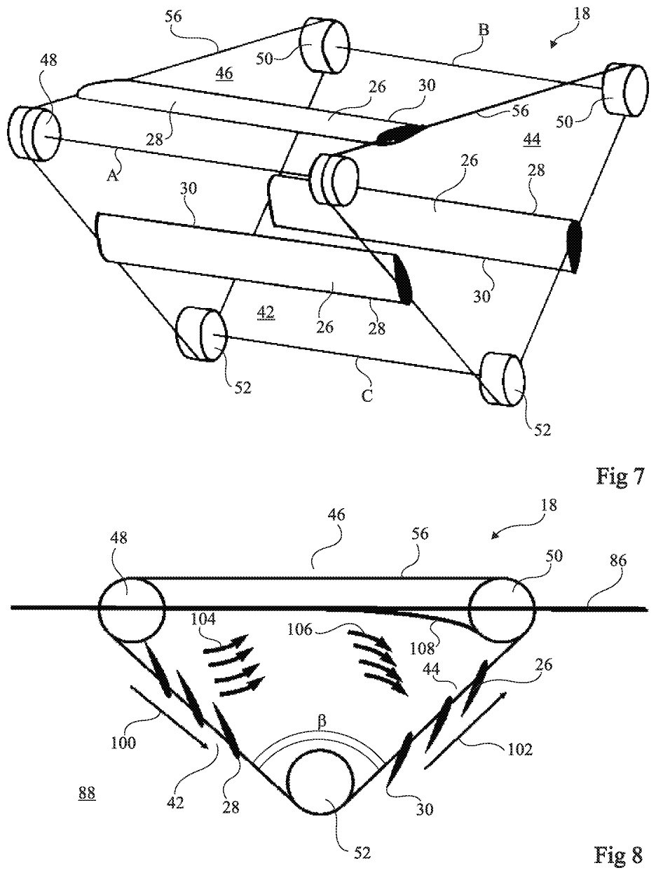

FIGS. 7 and 8 respectively are a simplified perspective and side view of hydraulic turbine engine 10 illustrating the operation thereof. In FIGS. 7 and 8, the only elements of hydraulic turbine engine 10 which are schematically shown are certain blades 26 (three in FIG. 7 and six in FIG. 8), wheels 48, 50, and 52, chains 56 and, in FIG. 7, rotation axes A, B, and C respectively of upper front wheels 48, of upper back wheels 50, and of lower wheels 52. Further, in FIG. 8, the free surface of the stream 88 into which hydraulic turbine engine 10 is partially submerged has been represented by a line 86. As shown in FIG. 8, in the present embodiment, the upper travel area 46 of turbine 18 is not submerged in water stream 88.

Blades 26 are arranged so that, when blades 26 are located in upstream travel area 42, the leading edge 28 of blade 26 is lower than trailing edge 30 and that, when blades 26 are located in downstream travel area 44, the leading edge 28 of blade 26 is higher than trailing edge 30. The lift forces due to flow 88 which are exerted on blades 26 in upstream travel area 42 tend to have blades 26 move down towards the bottom of the water stream along the direction indicated by arrow 100. The lift forces due to flow 88 which are exerted on blades 26 in downstream travel area 44 tend to have blades 26 rise back up to the surface of water stream 88 along the direction indicated by arrow 102.

A general displacement of each chain 56 in the counterclockwise direction is thus obtained in FIG. 8. The displacement of chains 56 rotates wheels 48, 50, 52, and causes the driving of electromechanical converter 16. According to an embodiment, the displacement speed of each chain 56 is greater than the average velocity of flow 88 in upstream travel area 42, preferably in the range from 1 to 2 times the average velocity of flow 88 in upstream travel area 42.

Power coefficient K, which corresponds to the ratio of the mechanical power recovered by the chain (without taking into account the mechanical blades-to-chain drive efficiency) and the kinetic energy that can be recovered by the main cross-section of hydraulic turbine engine 10, is provided by the following relation (1):

K=Pₘ/(0.5*ρ*S*V³) (1)

where Pₘ is the mechanical power recovered by chain 56, S is the main cross-section of hydraulic turbine engine 10, ρ is the density of water, and V is the average velocity of flow 88 reaching upstream travel area 42. The main cross-section S of hydraulic turbine engine 10 is substantially equal to twice the area of the vertical rectangle having a width substantially equal to the span of blades 26 and having a height, measured vertically, equal to the submerged depth of hydraulic turbine engine 10. The inventors have shown by simulation that a power coefficient K varying from 0.43 to 0.51 is obtained when the velocity of chain 56 varies from 1 to 2 times the velocity of upstream flow 88.

Advantageously, the leading edge 28 of each blade 26 in upstream travel area 42 and in downstream travel area 44 is substantially horizontal. Given that in water streams, the velocity gradient of the flow is essentially vertical, the horizontal layout of the leading edges 28 of blades 26 enables, for each blade 26 in upstream travel area 42 and in downstream travel area 44, the flow seen by blade 26 to have a substantially constant velocity across the entire span of blade 26, which increases its hydrodynamic performance. The forces applied to blade 26 are thus substantially constant across the entire span of blade 26.

Advantageously, the displacement of blades 26 on upper travel area 46 is performed out of the water. Blades 26 are then only submitted to the aerodynamic drag, which is much lower than the hydrodynamic drag. There then advantageously is substantially no power loss due to the travel of blades 26 in upper travel area 46. Further, advantageously, no fairing protecting against flow 88 the blades 26 located in upper travel area 46 needs to be provided. The structure of hydraulic turbine engine 10 is thus simplified.

The free surface 86 of flow 88 creates a natural confinement effect which decreases the development of vertical velocity components of flow 88 downstream of the blades 26 located in upstream travel area 42, which is illustrated in FIG. 8 by arrows 104 and 106. Thereby, the velocity of flow 88 reaching blades 26 in downstream travel area 44 is substantially horizontal.

According to an embodiment, a redirection element 108 may be added to increase the velocity of the fluid reaching blades 26 in downstream travel area 44 and accordingly to increase the power developed by blades 26 in downstream travel area 44.

The dimensions of hydraulic turbine engine 10 are adapted to the envisaged application. According to an embodiment, the angle β defining the curve of the chain around lower wheel 52 is in the range from 60° to 120°. According to an embodiment, the span E of each blade 26 is in the range from 1 m to 8 m. According to an embodiment, the chord Co of each blade 26 is in the range from E/5 to E/10. According to an embodiment, the diameter of each wheel 48, 50, 52 is in the range from Co to 4*Co. According to an embodiment, the submerged depth of the hydraulic turbine engine is in the range from 0.5 m to 3 m, the limitation to 3 m being due to the scarcity of water veins allowing greater immersion depths.

According to another embodiment, upper travel area 46 is submerged in flow 88 close to the free surface 86 of flow 88, chains 56 being substantially in a horizontal direction in upper travel area 46. In this case, in upper travel area 46, blades 26 go against the flow. The confinement effect due to the free surface 86 of the water results in that the flow seen by blades 26 in upper travel area 46 is substantially horizontal. To decrease the hydrodynamic drag of flow 88 on blades 26 in upper travel area 46, blades 26 are substantially maintained horizontal in upper travel area 46. Such a self-confinement effect enables to do away with a fairing to protect the displacement of blades 26 against the flow.

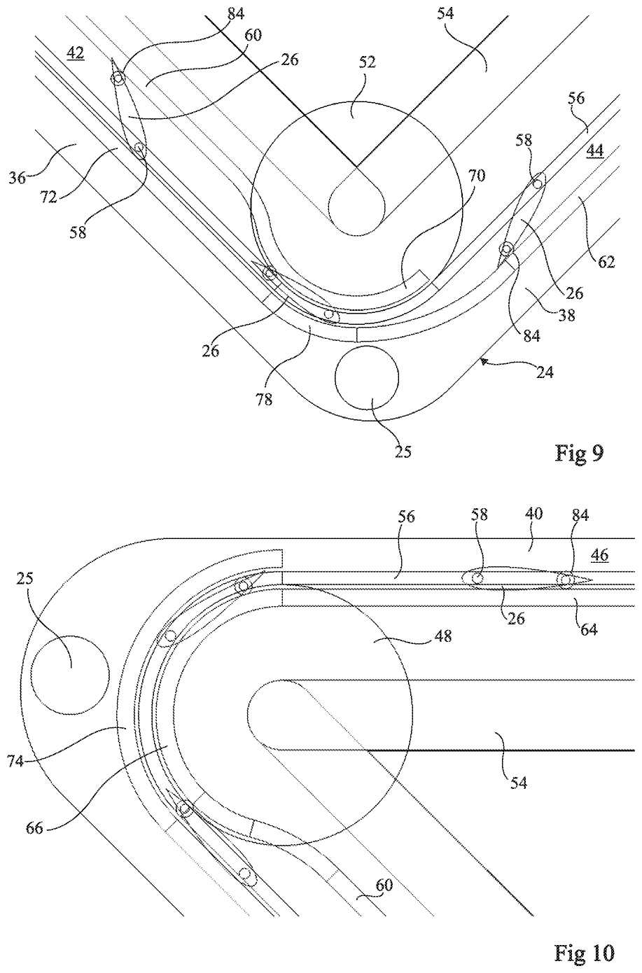

FIGS. 9 to 12 are partial simplified views of four different portions of the hydraulic turbine engine of FIG. 5 respectively at the level of lower wheel 52, of upstream upper wheel 48, of upstream travel area 42, and of downstream upper wheel 50.

As shown in FIG. 9, in upstream travel area 42, flow 88 tends to pivot blades 26 around the rotation axis of connection element 58 located in the front half of blade 26, so that the roller 84 located in the back portion of blade 26 abuts against main upstream guide 60. This sets the blade angle of blade 26 with respect to chain 56 in upstream travel area 42, that is, the angle between the chord of blade 26 and the direction of chain 56 in upstream travel area 42. This further sets the angle of incidence of the flow on blade 26 corresponding, in a vertical plane parallel to supports 24, to the angle between the chord of the blade and the direction of the relative flow seen by the blade. According to an embodiment, the incidence of each blade 26 in upstream travel area 42 is substantially constant whatever the position of blade 26 in upstream travel area 42. Secondary upstream guide 72 forms a stop to avoid, in upstream travel area 42, for blade 26 to pivot counterclockwise in FIG. 9, for example, during an installation or maintenance operation during which hydraulic turbine engine 10 is out of the flow.

As shown in FIG. 9, in downstream travel area 44, flow 88 tends to pivot blades 26 around the rotation axis of connection element 58 so that the roller 84 abuts against main downstream guide 62. This sets the blade angle of blade 26 with respect to chain 56 in downstream travel area 44 and the incidence of blade 26 in downstream travel area 44. According to an embodiment, the incidence of each blade 26 is substantially constant in downstream travel area 44 whatever the position of blade 26 in downstream travel area 44.

As shown in FIG. 9, during the transition between upstream travel area 42 and downstream travel area 44, during the progression of blade 26 around lower wheel 52, flow 88 tends to pivot blades 26 around the rotation axis of connection element 58 so that roller 84 abuts against main lower transition guide 70 and then against secondary lower transition guide 78, which brings blade 26 from the blade angle in upstream travel area 42 to the blade angle in downstream travel area 44. Thereby, the trailing edge of blade 26 is guided by main lower transition guide 70 or secondary lower transition guide 78 all along the displacement of lower wheel 52. This advantageously enables the wheel to recover power all along the turning of blade 26 around lower wheel 52.

As shown in FIG. 10, in upper travel area 46, blades 26 tend by gravity, if they are emerged or submerged but denser than water, to pivot around the rotation axis of connection element 58 so that roller 84 abuts against main upper guide 64.

This sets the blade angle of blade 26 with respect to chain 56 in upper travel area 46. According to an embodiment, the chord of each blade 26 in upper travel area 46 is substantially horizontal, whatever the position of blade 26 in upper travel area 46. If the blades 26 along upper travel area 46 are submerged and less dense than water, the buoyancy tends to pivot them around the rotation axis of connection element 58 counterclockwise. In this case, it may be advantageous to provide an secondary upper horizontal guide, not shown, above chain 56 so that roller 84 abuts against it, when the blades are stopped or when they are moving but the lift forces are insufficient to bring back the blades to their horizontal position.

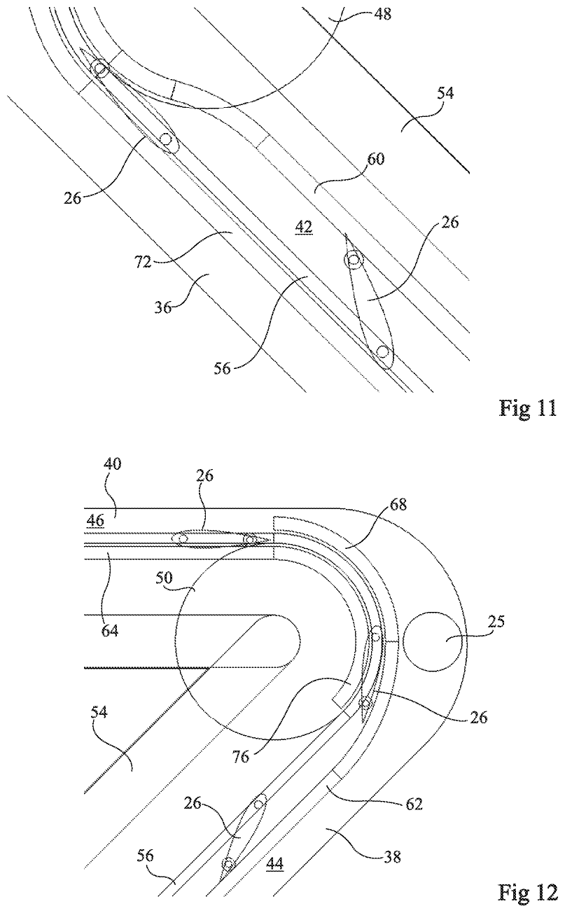

As shown in FIGS. 10 and 11, during the transition between upper travel area 46 and upstream travel area 42, during the progression of blade 26 around upper front wheel 52, roller 84 is guided by main upstream upper transition guide 66 or secondary upstream upper transition guide 74 to bring blade 26 from the blade angle in upper travel area 46 to the blade angle in upstream travel area 42. The two guides 66 and 74 are provided since, although flow 88 tends to have roller 84 abut against main upstream upper transition guide 66, conversely, centrifugal forces tend to have roller 84 abut against secondary upstream upper transition guide 74. In the case of emerged or submerged blades denser than water, gravity forces tend to have roller 84 abut against main upstream upper transition guide 66 at the beginning of a curve and against secondary upstream upper transition guide 74 at the end of the curve. In the case of submerged blades less dense than water, gravity forces tend to have roller 84 abut against secondary upstream upper transition guide 74 at the beginning of a curve and against main upstream upper transition guide 66 at the end of the curve.

As shown in FIG. 12, main downstream upper transition guide 68 and secondary downstream upper transition guide 76 enable to bring blade 26 from the blade angle in downstream travel area 44 to the blade angle in upper travel area 46. During the progression of blade 26 around upper back wheel 50, flow 88 and the centrifugal force tend to pivot blades 26 around the rotation axis of connection element 58 counterclockwise to have roller 84 abut against main downstream upper transition guide 68. In the case of emerged or submerged blades denser than water, gravity forces tend to have roller 84 abut against secondary downstream upper transition guide 76. In the case of submerged blades less dense than water, gravity forces tend to have roller 84 abut against main downstream upper transition guide 68. If the blades are less dense than water, it may be advantageous, due to buoyancy, to provide a secondary downstream guide, not shown, upstream of chain 56 so that roller 84 abuts against it, when the blades are stopped.

According to an embodiment, the angle of incidence of the flow on the blade is, in upstream travel area 42, in the range from 4° to 10°, for example, 7°, this angle of incidence depending on the type of blade cross-section used and on the chord Reynolds number Re=V*Co/ν, ν designating the kinematic viscosity of water. According to an embodiment, the angle of incidence on the blade is, in downstream travel area 44, equal to or a little lower than the angle of incidence of the flow on the blade in upstream travel area 42.

In the previously-described embodiments, each blade 26, in upstream travel area 42 and in downstream travel area 44, is connected to chains 56 in the first half of blade 26 and is connected to guides 66 or 68 in the second half of blade 26. The drag applied to blade 26 is then borne by chains 56 at the leading edge and by guides 66 and 68 at the trailing edge. This advantageously enables to increase the mechanical fatigue behavior of chains 56 and of wheels 48, 50, and 52 which only bear part of the drag of hydraulic turbine engine 10, the other part being borne by supports 24.

In the previously-described embodiments, blades 26 have a substantially rigid structure. According to an embodiment, blades 26 have a variable camber according to flow 88. This may be obtained by forming blades 26 at least partly with a material having some flexibility, for example, an elastomer or a composite material of fiberglass/carbon and resin type.

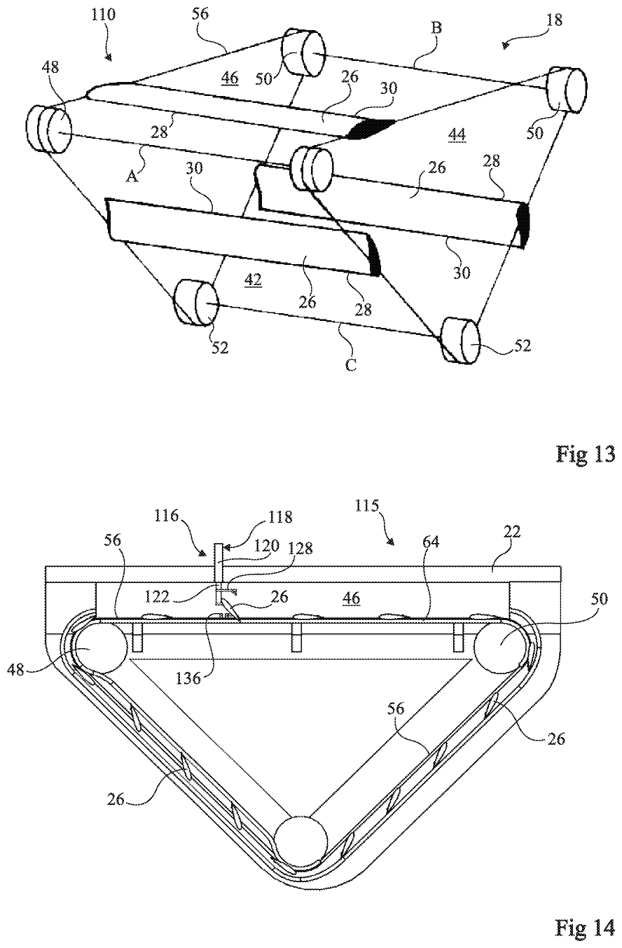

FIG. 13 is a view similar to FIG. 7 of an embodiment of a hydraulic turbine engine 110 comprising all the elements of hydraulic turbine engine 10, with the difference that blades 26 have a variable camber. Under the action of flow 88, blades 26 become cambered in upstream travel area 42, which increases their lift with respect to a camber-less profile. In upstream travel area 42, the camber of blades 26 is directed downstream. Further, blades 26 become cambered in downstream travel area 44, which increases their lift with respect to a camber-less profile. In downstream travel area 44, the camber of blades 26 is directed downstream. Preferably, in upper travel area 46, blades 26 have substantially no camber to decrease power losses due to the drag when they are submerged. The introduction of a camber enables to decrease the thickness of blades 26 in upstream and downstream travel areas 42 and 44 and thus to increase the efficiency of hydraulic turbine engine 110 with respect to hydraulic turbine engine 10.

FIG. 14 is a view similar to FIG. 7 of an embodiment of a hydraulic turbine engine 115 comprising all the elements of hydraulic turbine engine 10 and further comprising a system 116 for disengaging and engaging blades 26, partially shown in FIG. 14.

For each blade 26, disengaging and engaging system 116 enables to disengage blade 26 from chains 56. According to an embodiment, disengaging and engaging system 116 is configured to independently disengage each blade 26 from chains 56 when blade 26 is in upper travel area 46. In FIG. 14, a single blade 26 in disengaged position has been shown.

The possibility of independently disengaging each blade 26 enables to perform maintenance operations on blade 26 without having to take hydraulic turbine engine 115 out of the stream where it is installed. This also enables to protect blades 26 in the presence of floating bodies.

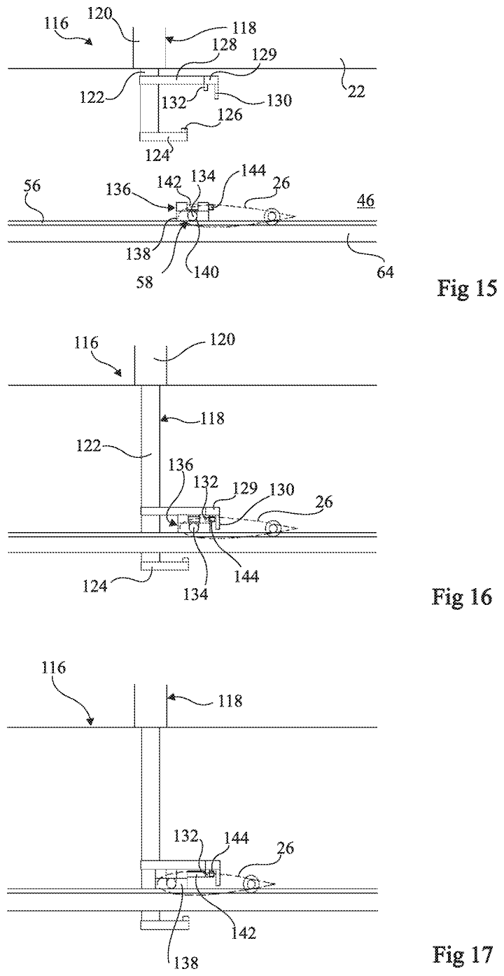

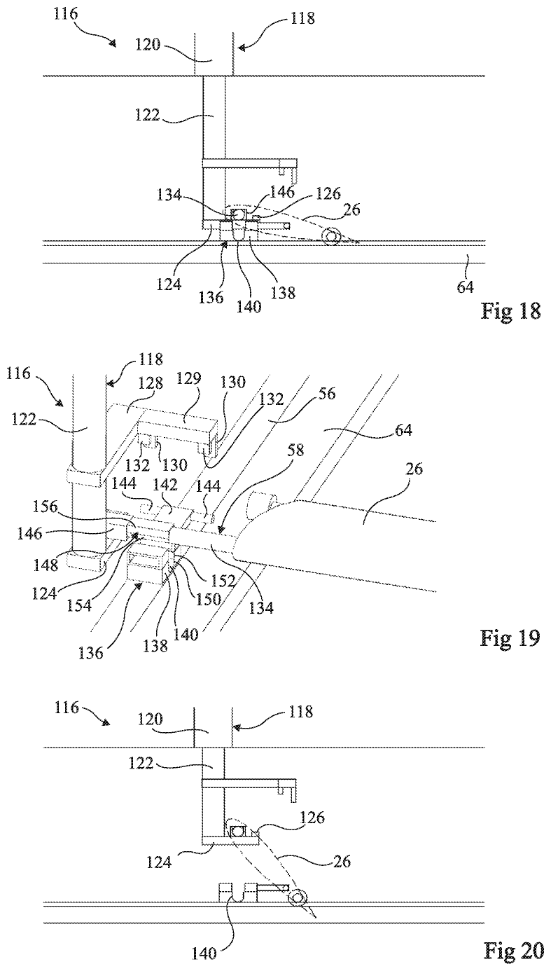

FIGS. 15 to 18 and 20 are partial simplified cross-section views of a portion of the hydraulic turbine engine 115 of FIG. 14 at successive steps of an operation of disengaging of a blade 26 and FIG. 19 is a perspective view of the portion of the hydraulic turbine engine shown in FIG. 18. In FIGS. 15 to 18 and 20, blade 26 is shown in dotted lines.

For each blade 26 and each chain 56, disengaging and engaging system 116 comprises a jack 118 comprising a body 120 and a rod 122 configured to more or less slide in body 120. Body 120 is secured to frame 22 of hydraulic turbine engine 115. Jack 118 may be an electric jack or a hydraulic jack. Jack 118 comprises a lower arm 124 secured to the end of rod 122 opposite to body 120. Lower arm 124 extends substantially perpendicularly with respect to the axis of rod 122. A slug 126 projects from the end of aim 124 opposite to rod 122 and is directed upwards. Jack 118 comprise a first upper arm 128 secured to rod 122, between body 120 and lower aim 124. First upper arm 128 extends substantially perpendicularly with respect to the axis of rod 122, preferably parallel to lower arm 124 and on the same side as lower arm 124. First upper arm 128 is continued at its end opposite to rod 122 by a second upper arm 129 which extends substantially perpendicularly to the first upper arm 128 on the side of blade 26. At each axial end of second upper arm 129, a slug 130 projects from the back edge of second upper arm 129 and is directed downwards. At each axial end of second upper arm 129, another slug 132 projects from the front edge of second upper arm 129 and is directed downwards. The length of each slug 130 is greater than the length of each slug 132.

In the present embodiment, for each blade 26 and each chain 56, the element 58 of connection of blade 26 to chain 56 comprises a shaft 134 which extends laterally on one side of blade 26 and an element 136 for locking shaft 134 to chain 56. Locking element 136 comprises a support 138 firmly attached to chain 56. Support 138 comprises a housing 140 receiving shaft 134 in engaged position and comprises a cover 142 mobile with respect to support 138 between a locked position where cover 142 covers housing 140 and an unlocked position where cover 142 does not cover housing 140. Cover 142 can be actuated between the locked and unlocked position via two lugs 144. As more clearly appears in FIG. 19, shaft 134 comprises an end portion 146 having a square cross-section and is continued, on the side of blade 26, by an intermediate portion 148 having a shape at least partly complementary to that of housing 140. As an example, in the present embodiment, housing 140 comprises a bottom 150 forming a semicylindrical hollow portion continued by substantially planar parallel lateral walls 152 and intermediate portion 148 comprises a semicylindrical bulged portion 154 directed downwards continued by two substantially parallel planar walls 156.

Disengaging and engaging system 116 further comprises a motor, not shown, capable of rotating at least one of wheels 48, 50 in one direction or the other rotation direction during a disengaging operation to be able to displace blades 26 in controlled fashion.

In a normal operation of the hydraulic turbine engine, the rods 122 of jacks 138 are sufficiently retracted into bodies 120 for jacks 138 not to hinder the motion of blades 126. Further, for each locking element 136, cover 142 is in closed position, thus preventing the displacement of shaft 134 out of housing 140. Shaft 134 is then firmly attached to chain 56 by the cooperation of intermediate portion 148 with housing 140 of locking element 136.

An operation of disengaging of a blade 26 comprises the following steps:

the blade 26 to be disengaged is displaced all the way to upper travel area 46 substantially vertically in line with the jack 118 associated therewith (FIG. 15);

jack 118 is actuated to have rod 122 slide with respect to body 120 so as to bring the second upper arm 129 closer to locking element 136 until each lug 144 inserts between slugs 130, 132, the length of lower arm 124 being adapted not to cooperate with shaft 134 during this displacement (FIG. 16);

the blade 26 to be disengaged is then displaced forwards over a short distance (FIG. 17) while jack 118 remains motionless. This causes the opening of cover 142 with respect to support 138 due to the cooperation of lugs 144 with slugs 132; and

jack 118 is actuated to slide rod 122 with respect to body 120 to draw lower arm 124 away from support 138 of locking element 136 (FIGS. 18, 19, and 20), lower arm 124 raising the end portion 146 of shaft 134 and, accordingly, blade 26. Slug 126 prevents the end portion 146 of shaft 134 from sliding backwards and from escaping from lower arm 124. FIGS. 18 and 19 show blade 26 during the raising while shaft 134 just comes out of housing 140 and FIG. 20 shows blade 26 at the end of the raising motion, blade 26 then being in disengaged position. Blade 26 may then be removed if need be.

FIGS. 20 to 23 are partial simplified cross-section views of a portion of hydraulic turbine engine 115 of FIG. 14 at successive steps of an operation of engagement of a disengaged blade 26. An operation of engagement of a blade 26 in disengaged position comprises the following steps:

chain 56 is actuated to bring the locking element 136 associated with blade 26 vertically in line therewith (FIG. 20), the cover 142 of locking element 136 being in open position;

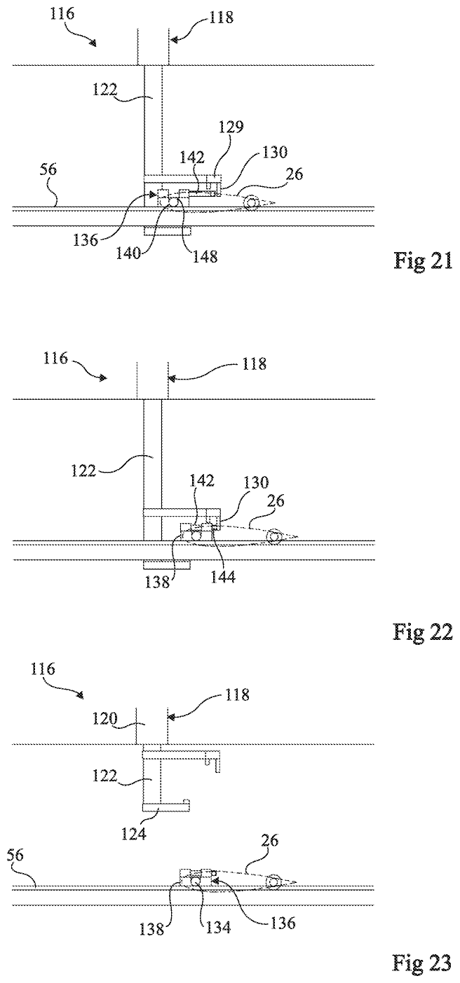

jack 118 is actuated to have rod 122 slide with respect to body 120 so as to bring the second upper arm 129 closer to locking element 136 until the intermediate portion 148 of shaft 134 penetrates into housing 140 and lugs 144 are located opposite slugs 130, 132 (FIG. 21);

the blade 26 to be disengaged is then displaced backwards over a short distance (FIG. 22) while jack 118 remains motionless. This causes the closing of cover 142 with respect to support 138 due to the cooperation of lugs 144 with slugs 130; and

jack 118 is actuated to have rod 122 slide with respect to body 120 so as to draw the lower arm 124 away from the support 138 of locking element 136 (FIG. 23), the length of lower arm 124 being adapted not to cooperate with shaft 134 during this displacement. Blade 26 is then connected again to chain 56.

In disengaged position, the chord of blade 26 forms with a vertical axis an angle smaller than 45°. The bulk along a horizontal direction of blade 26 in disengaged position is thus smaller than the bulk of blade 26 when it is connected to chain 56.

At least two blades 26 may be successively taken to the disengaged position. Preferably, all the blades 26 of hydraulic turbine engine 115 may be successively taken to the disengaged position.

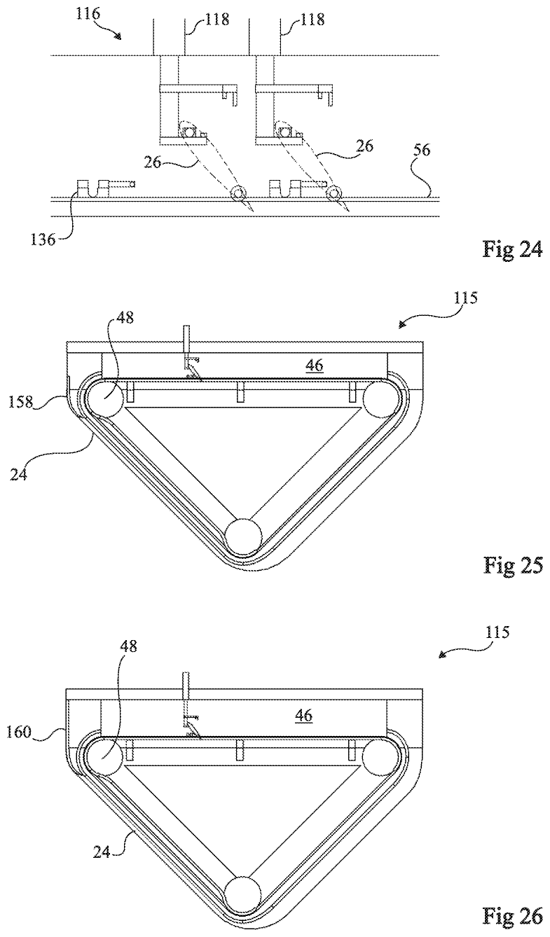

FIG. 24 is a partial simplified cross-section view showing two blades 26 in disengaged position. In this drawing, the left-hand blade 26 has been disengaged first. Chain 56 has been actuated to bring the right-hand blade 26 to the position vertically in line with the associated jack 118, which has caused a leftward displacement of the locking element 136 associated with the left-hand blade 26 and which remains firmly attached to chain 56.

It is desirable for the operation of disengaging of a blade 26 to be performed while hydraulic turbine engine 115 remains in the stream. It may be desirable for the blade 26 to be disengaged and jack 118 to be protected against the flow during the disengaging operation. Preferably, the bodies 120 of jacks 118 are permanently located out of the water.

FIG. 25 is a view similar to FIG. 14 of a variation of hydraulic turbine engine 115 in the case where upper travel area 46 is located substantially out of the water. Hydraulic turbine engine 115 comprises a deflector 158 secured to supports 24 upstream of upper front wheels 48 at the level of the submerged area of hydraulic turbine engine 115.

FIG. 26 is a view similar to FIG. 14 of a variation of hydraulic turbine engine 115 in the case where upper travel area 46 is substantially submerged in operation. Hydraulic turbine engine 115 comprises a deflector 160 secured to supports 24 upstream of upper front wheels 48 at the level of the submerged area of hydraulic turbine engine 115. The vertical dimension of deflector 160 is greater than the vertical dimension of deflector 158.

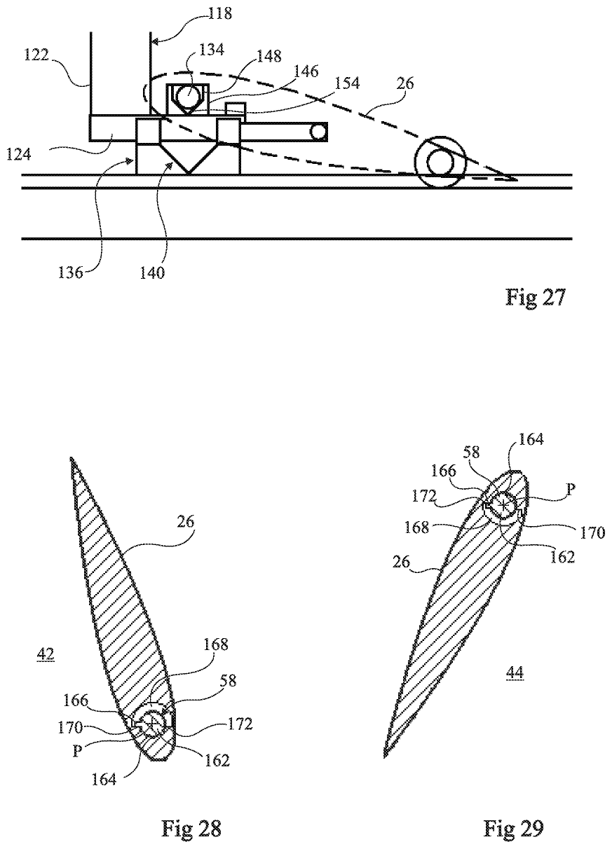

FIG. 27 is a partial simplified cross-section view of an alternative embodiment of the system for disengaging and engaging the hydraulic turbine engine of FIG. 14. According to this variation, housing 140 and intermediate portion 148 of shaft 134 have shapes which ease the automatic alignment of intermediate portion 148 with respect to locking element 136 upon engagement of blade 26. As an example, housing 140 takes a V shape and the bulged portion 154 of intermediate portion 148 also takes a V shape. Thereby, when the intermediate portion is lowered into housing 140 by jack 118, even if it is not perfectly vertically in line with housing 140, the walls of V-shaped portions 154 will cooperate with the walls of housing 140 to horizontally displace shaft 134 and bring V-shaped portion 154 down to the bottom of housing 140.

Embodiments of the disengaging and engaging system have been described for hydraulic turbine engines comprising guides 60, 62, 64, 66, 68, 70, 72, 74, 76, 78 which cooperate with the bearing elements 80 provided in the back portion of each blade 26. However, such embodiments of the disengaging and engaging system may be implemented with other blade guiding devices 26 which ensure the maintaining of the inclination of each blade 26 with respect to chains 56 in upstream travel area 42 and downstream travel area 44.

FIGS. 28 and 29 are cross-section view of a blade 26 respectively in upstream travel area 42 and in downstream travel area 44. In this embodiment, bearing elements 80 and guides 60, 62, 64, 66, 68, 70, 72, 74, 76, 78 are not present. Each connection element 58 comprises a cylindrical portion 162 of axis P which extends in a cylindrical housing 164 of blade 26 enabling blade 26 to pivot around axis P. Connection element 58 further comprises a lug 166 which projects outwards from cylindrical portion 164. Housing 164 is continued by a groove 168 containing the lug. Groove 168 extends in an arc of a circle corresponding to an angle substantially equal to the desired angular displacement of blade 26. The angular ends of groove 168 form two stops 170, 172. In FIG. 28, when blade 26 is in upstream travel area 42, blade 26, under the action of the flow, pivots with respect to connection element 58 until lug 166 comes into contact with stop 170, which sets the inclination of blade 26 with respect to chain 56 in upstream travel area 42. In FIG. 29, when blade 26 is in downstream travel area 44, blade 26, under the action of the flow, pivots with respect to connection element 58 until lug 166 comes into contact with stop 172, which sets the inclination of blade 26 with respect to chain 56 in upstream travel area 144.

Specific embodiments have been described. Various alterations and modifications occur to those skilled in the art. In particular, although in previously-described embodiments, the hydraulic turbine engine comprises a single lower wheel 52, the hydraulic turbine engine may comprise at least two lower wheels, for example, an upstream lower wheel and a downstream lower wheel. The upstream travel area then extends between the front upper wheel and the upstream lower wheel and the downstream travel area extends between the downstream lower wheel and the downstream upper wheel. The hydraulic turbine engine further comprises a lower travel area between the upstream lower wheel and the downstream lower wheel.

Further, it is possible to associate a plurality of hydraulic turbine engines such as previously described, for example by placing the hydraulic turbine engines along a line perpendicular to the flow, the hydraulic turbine engines being secured to one another, for example, via floats 20 and/or supports 24 to decrease, or even to suppress, the passing of flows between two adjacent hydraulic turbine engines.

Various embodiments with different variations have been described hereabove. It should be noted that those skilled in the art may combine these various embodiments and variations without showing any inventive step.

1. A hydroelectric power plant for a water stream comprising an electromechanical converter and a turbine capable of driving the electromechanical converter, the turbine comprising two vertical supports parallel to the stream flow, a float connected to each support and, between the supports, driving blades moved by hydrodynamic lift forces, connected at each end to a drive component comprising a chain or a belt forming a closed loop, the turbine further comprising wheels driven by the drive component and assembled on the supports, each blade comprising a leading edge and a trailing edge, the hydroelectric power plant comprising at least first, second, and third travel areas where each drive component extends rectilinearly, the leading edges of the blades being arranged horizontally plus or minus 5° at least in the first and second travel areas, the blades being fully submerged at least over a portion of the first and second travel areas, and wherein each support comprises guides and wherein each blade comprises elements capable of abutting against the guides.

2. The hydroelectric power plant of claim 1, wherein each blade is assembled to freely rotate with respect to the drive components around an axis located in the blade half on the side of the leading edge of the blade.

3. The hydroelectric power plant of claim 2, wherein, for each blade, the elements are secured to the blade in the blade half on the side of the trailing edge of the blade.

4. The hydroelectric power plant of claim 3, wherein the guides of each support comprise a first rectilinear guide in the first travel area, downstream, according to the stream flow direction, of the drive component in the first travel area, and a second rectilinear guide in the second travel area, downstream, according to the water stream flow direction, of the drive component in the second travel area.

5. The hydroelectric power plant of claim 1, further comprising a system for disengaging and engaging at least one of the blades with respect to the drive component.

6. The hydroelectric power plant of claim 5, wherein the disengaging and engaging system comprises a locking element firmly attached to the drive component and comprising a housing, the blade being continued by a shaft having a portion located, in an engaged position, in the housing, the disengaging and engaging system further comprising a jack configured to displace the shaft from the engaged position to a disengaged position where the shaft is outside of the housing and to displace the shaft from the disengaged position to the engaged position.

7. The hydroelectric power plant of claim 5, wherein the disengaging and engaging system is configured to successively disengage each blade with respect to the drive component in a first order and to successively engage each blade in a second order opposite to the first order.

8. The hydroelectric power plant of claim 1, wherein, in a vertical plane parallel to the supports, the leading edge of each blade is capable of displacing rectilinearly in each of the first, second, and third travel areas.

9. The hydroelectric power plant of claim 1, wherein the blades are totally emerged in the third travel area.

10. The hydroelectric power plant of claim 9, wherein the blades displace substantially horizontally plus or minus 5° in the third travel area.

11. The hydroelectric power plant of claim 1, wherein the blades are capable, under the action of hydrodynamic forces, of cambering in the downstream direction in the first and second travel areas.

12. The hydroelectric power plant of claim 1, wherein, for each blade and for each drive component, the blade is assembled to freely rotate around an axis with respect to a connection element secured to the drive component between a first relative inclination between the blade and the connection element and a second relative inclination between the blade and the connection element, the blade and/or the connection element comprising stops configured to block the rotation of the blade with respect to the connection element in a first rotation direction around said axis with the first inclination and in a second rotation direction around said axis, opposite to the first rotation direction, with the second inclination.
